(19) United States
(12) Patent Application Publication
(10) Pub. No.: US 2005/0241238 A1
(43) Pub. Date: Nov. 3, 2005

(54) Finger protector device

(76) Inventor: Frank Garvey, Manchester (GB)

Correspondence Address: ADAMS EVANS P.A., 2180 TWO WACHOVIA CENTER, CHARLOTTE, NC, 28282, US

(21) Appl. No.: 10/513,246

(22) PCT Filed: Apr. 28, 2003
(86) PCT No.: PCT/GB03/01798

§ 371 Date: Jun. 20, 2005

(30) Foreign Application Priority Data
May 2, 2002 (GB) 0210076.6

(51) Int. Cl. E06B 7/16; E05D 11/00

(52) U.S. Cl. 49/383

(57) ABSTRACT

A finger protection device (2) for a door or window comprising attachment means (5) for attachment to either a door or window or a corresponding door/window frame, which door or window is arranged for relative movement with respect to its frame, and abutment means (4) connected to the attachment means (5) and biased towards an opening created by movement of the door or window out of its corresponding frame.

### FIELD OF THE INVENTION

The present invention relates to finger protector devices, and particularly, although not exclusively, to finger protector devices for use with sliding and hinged doors.

### BACKGROUND TO THE INVENTION

Sliding doors, for example, patio doors, are arranged such that on sliding a door from a closed position to an open position, a door opening is formed between an edge of the door and an adjacent door-frame to which the door is mounted. On sliding the door back into the closed position, the size of this door opening is reduced until the edge of the door completely engages the adjacent door-frame. Any objects protruding into the decreasing opening during the closing of the door, may become squeezed or trapped therein. Frequently, fingers become trapped between the door and the adjacent door-frame during closing which tends to be very painful.

Similarly, a door which is mounted to a door-frame by hinges, also forms a gap between the edge of the door carrying the hinges (or the opposite edge) and the adjacent door-frame when it is opened. As with sliding doors, on closing hinged doors the gap is inevitably reduced until the door engages the door-frame which may result in injury if fingers are inserted therein.

It is an aim of the present invention to address the problems associated with sliding and hinged doors.

### SUMMARY OF THE INVENTION

According to a first aspect of the invention, there is provided a finger protection device for a door or window comprising attachment means for attachment to either a door or window or a corresponding door/window frame, which door or window is arranged for relative movement with respect to its frame, and abutment means connected to the attachment means and biased towards an opening created by movement of the door or window out of its corresponding frame.

The door-frame or window frame may include an adjacent surface, for example, a wall. The door or window may comprise a sliding door or sliding window arranged for relative movement with respect to its frame. Alternatively, the door or window may comprise a hinged door or hinged window arranged for relative movement with respect to its frame.

The door frame or window frame may be integral with, or used on, a vehicle, for example, buses, tubes, people carriers, loading vehicles, where either hinged door or sliding door arrangements are commonplace.

Preferably, in a first embodiment, the attachment means comprises a substantially planar base which may comprise an aperture through which fixing means may extend into the first or second surface. Alternatively, or additionally, the base may be attached to either the first or the second surface by adhesive or Velcro™.

The finger protection device may comprise a securing plate which may be secured to either the first or the second surface by suitable means and to which the attachment means may be attached. The securing plate may be secured to either the first or the second surface by suitable fixing means, and the attachment means may be attached to the securing means by suitable means, for example, Velcro™. The finger protection device may additionally comprise cover means adapted to be attached to the securing means, preferably when the securing means is not in use, for example, if the abutment means and attachment means have been removed.

The abutment means may comprise a head section and preferably a neck section connected thereto. Preferably, the head section is rigidly connected to the neck section. Preferably, the head section is substantially bulbous and solid and preferably, dense. Preferably, the neck section is substantially elongate and hollow and preferably, less dense than the head section. Advantageously, the neck section may comprise side walls which may flex thereby allowing shocks to be absorbed therealong.

Preferably, the said neck section is connected to the attachment means by suitable means. Preferably, the neck section is connected to the attachment means by a friction fit operable to urge the head section in a direction towards the space between the first and second surfaces, i.e. a closed position. Alternatively, or additionally, the friction fit may maintain the abutment means away from the space between the first and second surfaces, i.e. an open position.

Preferably, the planar base comprises first and second spaced apart flanges extending therefrom. Preferably, the abutment means, preferably the neck section thereof, are resiliently maintained between the flanges in either the open or closed position. Preferably, the first flange comprises a protrusion extending towards the second flange, and vice versa. Preferably, the neck section of the abutment means comprises protrusion receiving means which may comprise a channel extending therethrough.

Preferably, the or each protrusion is generally circular in cross-section. Preferably, the or each protrusion comprises at least one recess located around the circumference thereof. Preferably, the or each protrusion comprises at least two recesses located at spaced apart positions around the circumference thereof. Preferably, the positions of the first and second recesses in the first protrusion correspond with the positions of the first and second recesses in the second protrusion. Preferably, the first and second recesses correspond to the closed and open positions of the abutment means with respect to the door frame, respectively.

Preferably, the protrusions are accommodated by the receiving means and operable to bias the head section towards the closed position between the door or window and door/window frame. Preferably, the protrusion receiving means is sized to accommodate the or each protrusion of the attachment means. Preferably, the protrusion receiving means comprises engagement means adapted to engage the or each recess in the protrusion. Preferably, the engagement means is substantially resilient. Preferably, the engagement means comprises a finger or flange extending away from an outer wall of the neck section, which finger or flange preferably, forms a surface which defines an inner region of the protrusion receiving means.

Preferably, the engagement means comprises a terminal node adapted to fit in the or each recess in the protrusion. Preferably, the terminal node or head is distal from the site of origin from the outer wall.

Preferably, and advantageously, the abutment means may be adapted to move between the open and closed positions. The engagement means may engage the first recess when in the closed position, and preferably the second recess when in the open position.

Advantageously, and preferably, the abutment means is biased when in the closed position such that it is urged to fill the space created between the door (or window) and door-frame (or window frame). Therefore, when an operator wishes to close the door or window, the abutment means must be removed from the space.

Advantageously, if the door is closed accidentally, for example, by a gust of wind etc, and the abutment means has not been moved out of the space, then the door will be unable to fully engage the door-frame and a gap the width of the abutment means will still remain. This is particularly advantageous when children may have their fingers inserted in between the door (window) and the door-frame (window frame) at the time the door accidentally closes.

Preferably, the abutment means may be manually urged in a direction which is substantially opposite to the first direction away from the space between the door or window and door/window frame. The abutment means may be maintained in the open position by engagement of the engagement means in the second recess. Preferably, upon release, the abutment means returns to the space between the door or window and door/window frame.

Preferably, in the second embodiment, the abutment means comprises a head section. Preferably, the head section is substantially bulbous. The head section may be solid and preferably, dense. Alternatively, the head section may be substantially hollow, in which case the head section may comprise at least one strengthening rib extending thereacross.

Preferably, the finger protection device comprises securing means, which may be secured to either the door or window or a corresponding door/window frame by suitable means. The securing means may be secured to either the door or window or a corresponding door/window frame by adhesive, Velcro, screws, etc. Preferably, in a second embodiment, the securing means comprises a securing strip.

Preferably, the attachment means is adapted to be attached to the securing means. Preferably, in a second embodiment, the attachment means comprises two arms, which preferably extend transversely away from a substantially flat surface. Preferably, the distance between the two arms of the attachment means is substantially the same as the width of the securing means. Preferably, in the second embodiment, the attachment means is snap fitted or slid on to the securing means.

Preferably, the abutment means, preferably the attachment means, and preferably the securing means are extruded. The device may be provided in different lengths. Advantageously, the second embodiment of the device may be simply cut to any desired length giving great versatility.

Preferably, the attachment means is connected to the abutment means by a hinge, which is preferably biased. Preferably, the hinge is plastic or rubber.

Advantageously, and preferably, the abutment means is biased preferably by the hinge, such that it is urged to fill the opening created between the door (or window) and door-frame (or window frame). Therefore, when an operator wishes to close the door or window, the abutment means must be manually removed from the opening.

Preferably, the abutment means may be manually urged away from the space between the door or window and door/window frame. Preferably, upon release, the abutment means returns to the opening between the door or window and door/window frame.

According to a second aspect of the present invention there is provided a method of protecting a finger from becoming trapped in between a door or window and door/window frame which door or window is arranged for relative movement with respect to its frame, the method comprising attaching a finger protection device according to the first aspect to either the door or window or the door/window frame.

All the features described herein may be combined with any of the above aspects, in any combination.

### BRIEF DESCRIPTION OF THE DRAWINGS

For a better understanding of the invention, and to show how embodiments of the same may be carried into effect, reference will be made, by way of example, to the accompanying drawings, in which:—

FIG. 1 is a schematic perspective view of a first embodiment of a finger protection device;

FIG. 2 is a schematic perspective view of the first embodiment of the finger protection device in a closed configuration;

FIG. 3 is a schematic cross-sectional view of the first embodiment of the finger protection device in a closed configuration;

FIG. 4 is a schematic cross-sectional view of the first embodiment of the finger protection device in an open configuration;

FIGS. 5a and 5b are schematic perspective views of a second embodiment of the finger protection device;

FIG. 6 is a schematic plan view of the second embodiment of the finger protection device;

FIG. 7 is an enlarged plan view of the second embodiment of the finger protection device; and

FIG. 8 is an alternative enlarged plan view of the second embodiment of the finger protection device.

### DESCRIPTION OF PREFERRED EMBODIMENTS

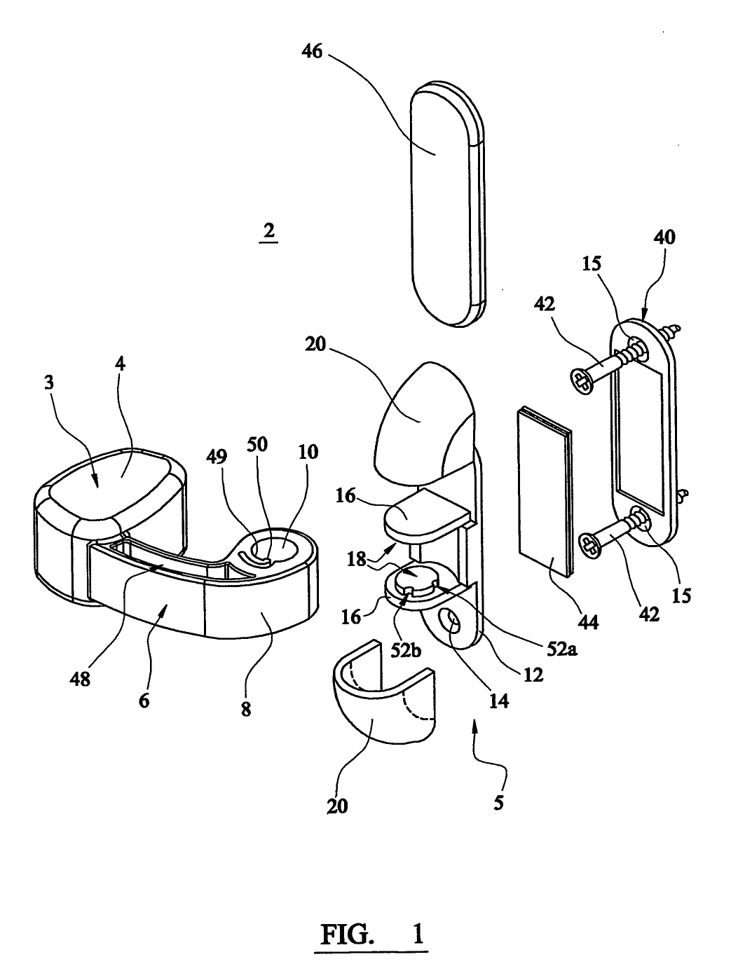

Referring to FIG. 1, there is shown a first embodiment of a finger protection device 2 in exploded view showing its components. The device 2 generally consists of an abutment member 3 and an attachment member 5 which are secured together to form the complete finger protection device 2. The abutment member 3 is manufactured out of high-density rubber and the attachment member 5 is manufactured out of a rigid polymer.

As shown in FIGS. 1 to 4, the abutment member 3 of the first embodiment of the device 2 consists of a large head section 4 which is integral with an elongate neck section 6 having an inner region 48 cored out. The cored inner section 48 allows the outer walls of the neck section 6 to flex so that shocks may be absorbed therealong when in use. The neck section 6 extends into an attachment region 8 where it is connected to the attachment member 5.

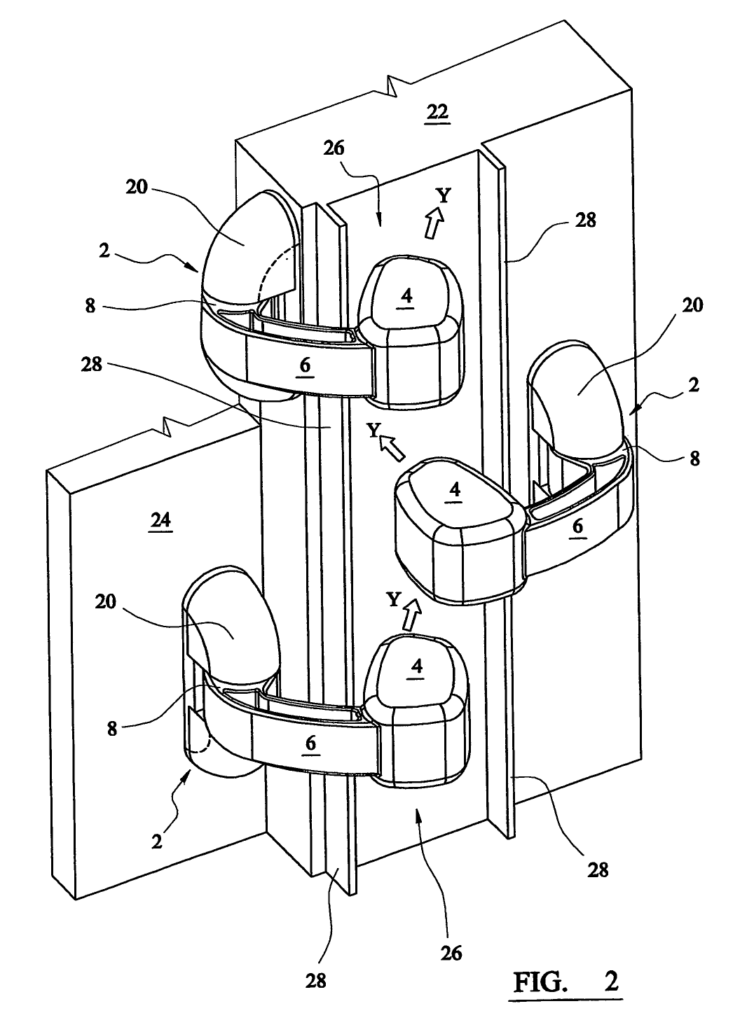

The attachment member 5 consists of a flat base 12 having an aperture 14 at either end thereof. The attachment region may be mounted directly onto a surface, for example, a door-frame 22 as shown in FIG. 2, by passing screws 42 through the apertures 14 of the base 12. Removable covers 20 are attached to the base 12 over the apertures 14 in order to hide the screw heads projecting therethrough.

The underside of the base 12 may be covered with Velcro™ 44 for fastening to the door-frame 22 which is also covered in a suitably shaped region of Velcro™ 44 at the desired location. Alternatively, the device 2 may additionally include an optional wall mounting plate 40 which is secured directly in the door frame 22 by passing screws 42 through apertures 15 extending therethrough. The surface of the mounting plate 40 which faces away from the door frame 22 is covered in Velcro™ 44 and provides a surface to which the Velcro 44 underside of the base 12 may be attached. An optional cover 46 may be attached by Velcro™ 44 to the exposed Velcro™ surface of the mounting plate 40 if the attachment member 5 is removed.

Two parallel spaced apart flanges 16 extend from the base 12 of the attachment member 5 and form a small gap therebetween. Two protrusions 18 extend from the sides of the flanges 16 into the gap and point towards each other. The two protrusions 18 are generally circular cross-section except for two small recesses 52a,52b located at spaced apart positions around the circumference thereof.

The attachment region 8 of the abutment member 3 is provided with a channel 10 having a generally circular cross-section which extends through the attachment region 8. The channel 10 is sized to accommodate the protrusions 18 on the attachment member 5. In addition, the attachment region 8 of the abutment member 3 includes a resilient finger 49 having a head section 50 which is of a similar size as the two recesses 52a,52b in each protrusion 18. The head 50 of the finger is resilient such that it can flex in an out of the channel 10 as will be described hereinafter.

The abutment member 3 is connected to the attachment member 5 by gently prising the two flanges 16 apart and allowing the protrusions 18 to snap fit into either side of the channel 10. Due to the resilience of the finger 49, the head 50 is urged to rest in either of the two recesses 52a,52b in each protrusion 18 depending on whether it is desired to have the device 2 in an open or closed configuration. The components of the finger protection device 2 are maintained together by a friction fit.

Referring to FIG. 2, there is shown a sliding door arrangement consisting of a door-frame 22 attached to a wall 24. The door-frame 22 has two parallel flanges 28 extending therefrom which form a door-engaging channel 26 therebetween. For clarity, the door, which engages with the channel 26, is not shown.

FIG. 2 shows three finger protection devices 2 (first embodiment) attached to three different surfaces which are all adjacent the door-engaging channel 26 and which are all in a closed configuration only one finger protection device 2 needs to be used for each door in practice; three are shown merely for illustrative purposes. Each of the devices 2 is mounted so that the head section 4 of the abutment member 3 is biased or urged in the direction of arrow Y such that it is positioned in the channel 26. This is achieved by arranging the abutment member 3 with respect to the attachment member 5 so that the head 50 of the finger 49 is positioned in recess 52b. This can be done manually by an operator. FIG. 3 shows a cross-sectional view along two of the three devices 2 illustrating the head 50 engaging recess 52b. Hence, the abutment member 3 is biased into the closed configuration in the direction shown by arrow Y.

Referring to FIG. 4, there is shown a cross-sectional view of a finger protection device 2 (first embodiment) in an open configuration with respect to the door frame 22. The abutment member 3 has been pulled by an operator away from the door frame 22 in a direction opposite to arrow Y shown in FIG. 3 so that the head 50 of the finger 49 is moved from recess 52b to recess 52a. The abutment member 3 is temporarily maintained in this open configuration allowing the free opening and closing of the sliding door (not shown).

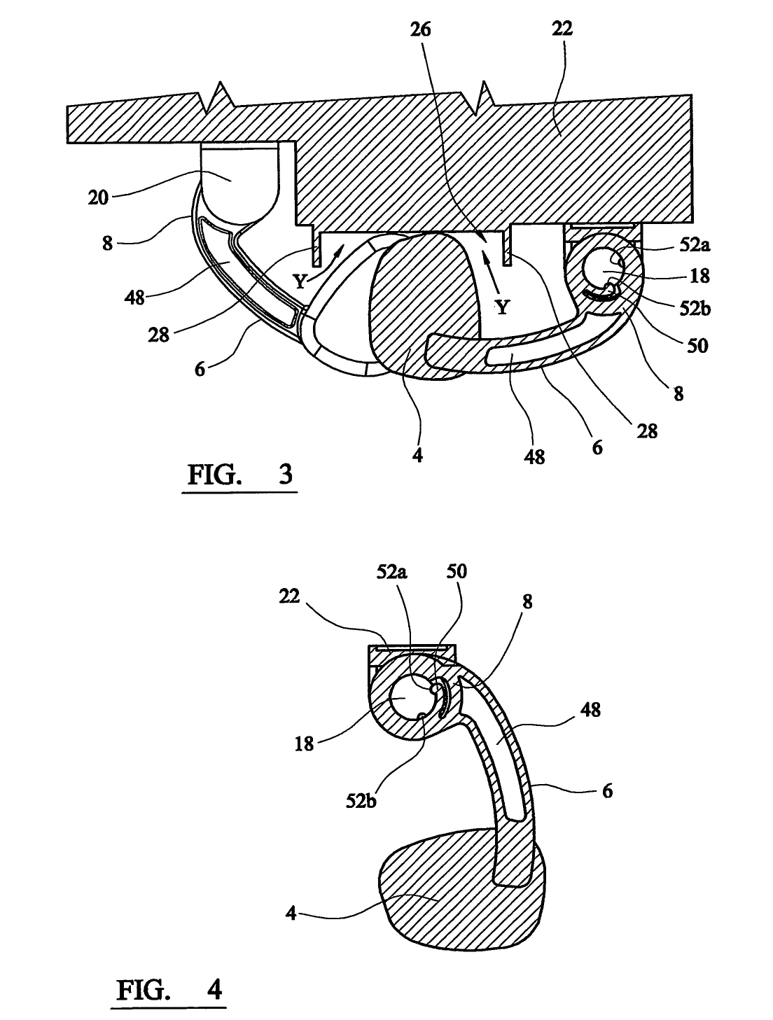

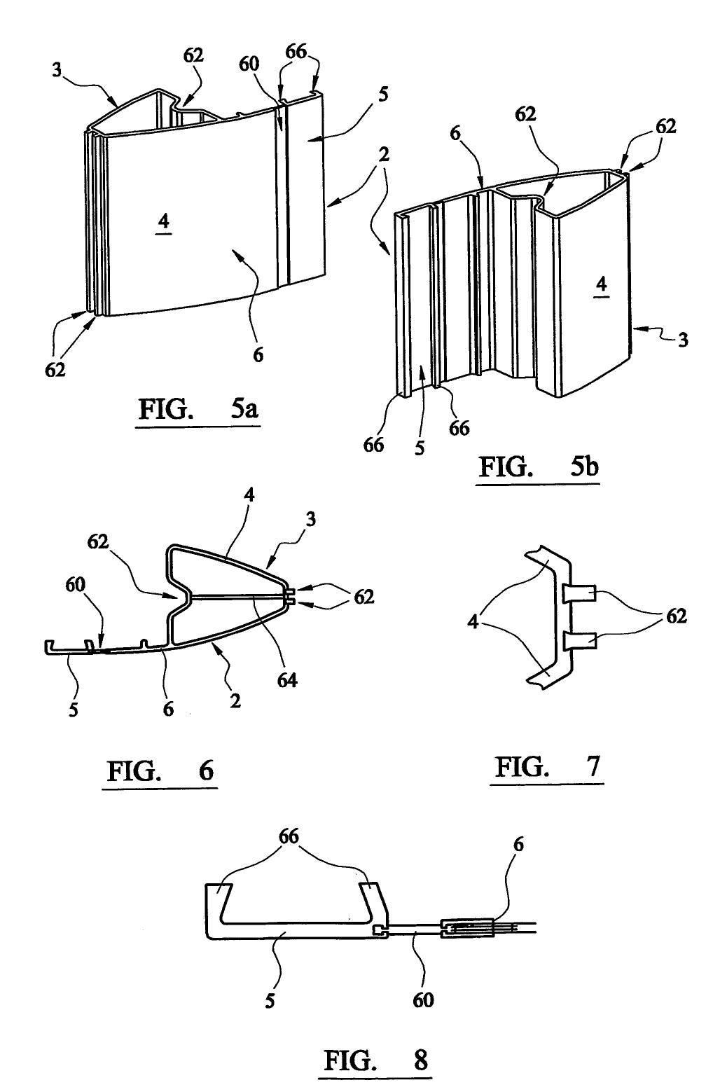

Referring to FIGS. 5-8, there is shown a second embodiment of the finger protection device 2. The second embodiment of the device 2 consists of an abutment member 3 and an attachment member 5 which are linked together by a hinge 60 to form the complete finger protection device 2. The abutment member 3 and attachment member 5 are manufactured out of uPVC, and the hinge 60 is manufactured out of a resilient plastic/rubber material, for example, nitrile. The second embodiment of the device 2 is formed as an extrusion.

As shown in FIGS. 5a, 5b and 6, the abutment member 3 of the second embodiment of the device 2 consists of a large head 4. The head 4 has a shape similar to an arrow head, tapering from a larger end wall at the side of the head 4 which is proximal to the hinge 60 and attachment member 5, to a narrower end wall at the side of the head which is distal to the attachment member 5. The larger end wall has a small recess 62, which is present to accommodate a locking mechanism of the door or window to which the device is attached. On the external side of the narrower end wall, there are provided two plastic/rubber strips 62 which extend therealong parallel with each other. The strips 62 are present to absorb impact along the head 4.

As shown in FIG. 6, a strengthening rib 64 extends between the larger and narrower end walls to provide the head 4 with strength to resist impacts. It should be appreciated that further strengthening ribs 64 could be provided within the head 4. Alternatively, the head 4 could be made from a solid material throughout.

Referring to FIG. 8, the attachment member 5 is shown consisting of a flat extrusion which has two short arms 66 at either end thereof, which arms 66 extend transversely away therefrom on the same side as the head 4. The attachment member 5 is attached to the head 4 via the resilient hinge 60.

In use, the second embodiment of the finger protection device 2 is fixed in position adjacent to a door or window engaging channel 26 of the sliding door or sliding window arrangement as shown in FIG. 2. This is achieved by initially fixing an attachment strip (not shown) thereto at the desired location adjacent the channel 26. The attachment strip consists of an elongate plastic extrusion, which can be cut to size and then attached adjacent to the door engaging channel 26, by suitable means, for example, adhesive, Velcro, double-sided sticky tape, etc.

Once the attachment strip is in position adjacent the channel 26, the two short arms 66 of the attachment member 5 of the device 2 are then either slid over or snap-fitted on to the attachment strip at a suitable position such that the head 4 of the abutment member 3 is biased or urged in to the channel 26. The arrangement of the second embodiment of the device 2 is then very similar to that of the first embodiment. The hinge 60 of the device 2 biases the head 4 into the channel 26 so that it is in the closed configuration. As with the first embodiment of the finger protection device 2, the biasing effect of the head 4 into the channel 26 prevents the door or window (sliding or hinged) from completely closing, unless the head 4 has been pulled by an operator out of the channel 26 into a disengaged position.

Advantages of both embodiments of the finger protection device reside in the fact that the head section 4 is always biased in the direction of the channel 26 in the door-frame. In the first embodiment, this is achieved by the provision of the recess 52b in which the head 50 of resilient finger 49 may be temporarily accommodated. In the second embodiment, this is achieved by the resilient hinge 60. Therefore, when the door (not shown) is opened, the head member 4 is always urged to lie in the gap or space produced between the internal face of the door and the channel 26. Therefore, if one wishes to fully close the door, then one must manually pull the head section 4 out of the channel 26 in the opposite direction to arrow Y such that the door can fully engage the door-frame 22.

If the door is accidentally closed, for example, by a gust of wind, and the head section 4 has not been moved out of position by an operator, then the door will be unable to fully engage the door-frame 22 and a gap the width of the head section 4 will still remain. This is particularly advantageous when children may have their fingers inserted in between the door and the door-frame at the time the door closes. The cored out section 48 of the neck section 6 allows the outer walls to flex absorbing shocks therealong.

Once fully closed, the head section 4 of the device 2 can then be released, allowing it to rest against the side of the closed door or window. Upon opening the door, the biasing nature of the attachment region 8 in the first embodiment and hinge 60 in the second embodiment urges the head section 4 automatically back into position in the gap between the door and the door-frame 22. Hence, the device 2 is a fail-safe mechanism for ensuring that, when the door is open, there will always be a safety gap.

If one wishes to maintain the first embodiment of the device 2 in the open configuration, the abutment member 5 may be pulled back so that the head 50 of resilient finger 49 temporarily accommodates recess 52a.

Additional benefits of the second embodiment of the device 2 are that no screws are required for attachment. In addition, no tools are required for fitting. Finally, because the entire device is formed as an extrusion, it is possible to provide the device 2 in different lengths, for example, 2 cm (small), 10 cm (medium), and 30 cm (large) lengths. Alternatively, a customer could purchase a long strip of the device 2 and attachment strip, and cut these to what length he wishes as necessary before fitting adjacent the channel 26.

The device 2 may be used in conjunction with a hinged door in the same way as for sliding doors, but on the hinged edge of the door or the opposite edge. The hinged door could be a car door, for example. Additionally, the device 2 may be placed on or around a window frame and would function in a similar way as on the door or door-frame 22.

The reader's attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings), may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends to any novel one, or any novel combination, of the features disclosed in this specification (including any accompanying claims, abstract and drawings), or to any novel one, or any novel combination, of the steps of any method or process so disclosed.

1. A finger protection device for a door or window comprising attachment means for attachment to either a door or window or a corresponding door/window frame, which door or window is arranged for relative movement with respect to its frame, and abutment means connected to the attachment means and biased towards an opening created by movement of the door or window out of its corresponding frame.

2. A finger protection device as claimed in claim 1, wherein the door or window comprises a sliding door or sliding window arranged for relative movement with respect to its frame.

3. A finger protection device as claimed in claim 1, wherein the door or window comprises a hinged door or hinged window arranged for relative movement with respect to its frame.

4. A finger protection device as claimed in claim 1, wherein the door frame or window frame is integral with, or used on, a vehicle, for example, buses, tubes, people carriers, loading vehicles, where either hinged door or sliding door arrangements are commonplace.

5. A finger protection device as claimed any preceding claim, wherein the abutment means comprises a head section.

6. A finger protection device as claimed in claim 5, wherein the head section is substantially bulbous.

7. A finger protection device as claimed in either claim 5 or claim 6, wherein the head section is solid and dense.

8. A finger protection device as claimed in either claim 5 or claim 6, wherein the head section is substantially hollow.

9. A finger protection device as claimed in claim 8, wherein the head section comprises at least one strengthening rib extending thereacross.

10. A finger protection device as claimed in any preceding claim, wherein the attachment means comprises two arms which extend transversely away from a substantially flat surface.

11. A finger protection device as claimed in any preceding claim, wherein the finger protection device comprises securing means which may be secured to either the door or window or a corresponding door/window frame by suitable means.

12. A finger protection device as claimed in any preceding claim, wherein the attachment means is adapted to be attached to the securing means.

13. A finger protection device as claimed in either claim 11 or claim 12, wherein the distance between the two arms of the attachment means is substantially the same as the width of the securing means.

14. A finger protection device as claimed in any of claims 11 to 13, wherein the securing means comprises a securing strip.

15. A finger protection device as claimed in any preceding claim, wherein the abutment means, attachment means and the securing means are extruded.

16. A finger protection device as claimed in any preceding claim, wherein the attachment means is connected to the abutment means by a hinge.

17. A finger protection device as claimed in claim 16, wherein the hinge is biased.

18. A finger protection device as claimed in any preceding claim, wherein the abutment means is biased such that it is urged to fill the opening created between the door (or window) and door-frame (or window frame).

19. A method of protecting a finger from becoming trapped in between a door or window and door/window frame which door or window is arranged for relative movement with respect to its frame, the method comprising attaching a finger protection device according to any of claims 1 to 18 to either the door or window or the door/window frame.

20. A finger protection device substantially as herein described with reference to, and as illustrated by, the drawings.

21. A method of protecting a finger substantially as herein described with reference to, and as illustrated by, the drawings.
